(19) United States
(12) Patent Application Publication
(10) Pub. No.: US 2021/0197539 A1
(43) Pub. Date: Jul. 1, 2021

(54) POLYMER FILM FOR IN-MOLD LABELING

(71) Applicant: Treofan Germany GmbH & Co. KG, Neunkirchen (DE)

(72) Inventors: Katja Weis, Rosenstraße 28a (DE); Yvonne Düpre, Enkenbach-Alsenborn (DE); Sandra Schmidt, Illingen (DE)

(21) Appl. No.: 16/608,397

(22) PCT Filed: Sep. 4, 2018
(86) PCT No.: PCT/EP2018/000173

§ 371 Date: Mar. 15, 2021

(30) Foreign Application Priority Data
Apr. 25, 2017 (DE) 10 2017 003 962.3

(51) Int. Cl. B32B 27/32; B32B 27/08; B32B 27/20; B32B 27/16; B32B 27/28; B32B 3/26; B29C 51/16

(52) U.S. Cl. CPC B32B 27/32; B32B 2264/025; B32B 27/205; B32B 27/16; B32B 27/283; B32B 3/26; B29C 51/16; B32B 2250/03; B32B 2250/04; B32B 2250/05; B32B 2250/24; B32B 2307/41; B32B 2307/408; B32B 2307/518; B32B 2307/538; B32B 2307/75; B32B 2307/746; B32B 2307/4026; B32B 2307/734; B32B 2270/00; B32B 2264/0257; B32B 27/08

(57) ABSTRACT

The invention relates to an opaque multilayer biaxially oriented polypropylene film comprising at least one vacuole-containing base layer and a printable outer cover layer and an inner matte cover layer, the inner cover layer containing at least two incompatible polymers and having a surface roughness Rz of at least 2.0 μm at a cut-off of 25 μm. The inner matte cover layer contains a polydialkylsiloxane having a viscosity of 100,000 to 500,000 mm²/s and the surface of this inner cover layer is surface treated by means of corona or the inner cover layer contains a siloxane-modified polyolefin.

The present invention relates to a label film for in-mold labeling (IML), and a method for producing these label films and their use.

Label films comprise an extensive and technically complex field. A distinction is made between different labeling techniques, which are fundamentally different in terms of process conditions and inevitably place different technical requirements on the label materials. A commonality of all labeling processes is that the end result must result in visually appealing labeled containers in which good adhesion to the labeled container must be ensured.

The labeling methods use very different techniques for applying the label. A distinction is made between self-adhesive labels, wrap-around labels, shrink labels, in-mold labels, patch labeling, etc. The use of a film made of thermoplastic as a label is possible in all these different labeling methods.

In-mold labeling also differentiates between different techniques that use different method conditions. A commonality in all in-mold labeling is that the label takes part in the actual molding process of the container and is meanwhile applied. However, very different molding processes are used, such as injection molding, blow molding and deep drawing.

In all in-mold labeling methods, individual labels are cut to size, stacked, removed from the stack and inserted into their respective molds. As a result, the separability (destackability) of the labels is a critical factor in the efficiency of the entire labeling process. The optimization of this destackability of the labels is the subject of numerous patent applications, which teach predominantly the setting of a special roughness of the inner and/or outer cover layer.

For the production of the printed labels, for cost reasons, large format sheets are cut off of the film, on which sheets several templates can be printed next to each other. In this process, the sheets are cut from the roll, underlapped, printed and the printed sheets are stacked. In order to ensure a high number of cycles in this printing process, the sheets are continuously cut off from the roll and the respectively newly cut sheet is partially pushed under the previous sheet, so that a series of shingled sheets is formed. The inside of the sheet to be printed and the outside of the following sheet come into contact for a short time here. The respective first sheet of this series is fed to the printing unit, printed and the freshly printed sheets are stacked. For the smooth process having a high number of cycles, the inner and the outer surface of the underlapped sheets must slide well against each other, must not adhere to each other, but also not slip against each other, that is, not shoot off. In alternative methods, the unprinted sheets are first stacked unprinted after being cut before being fed to the actual printing process.

The inside and the outside of the label film are then also in contact with each other here. In this variant, the destackability of the unprinted sheets is an important requirement.

The printed sheets are first stacked, then separated from the stack and the individual labels are punched out from the printed sheets and in turn also stacked. Alternatively, the labels can also be punched directly from the stacked printed sheets and used as a label stack in the injection molding process. The separation of the labels from label stacks thus produced is even more susceptible to interference, since the stamping process leads to a compaction of the stack.

For economic reasons, it is desirable to perform the printing of the sheets at a high speed, which could be further increased today due to optimized base films. However, there are always problems with unstacking the sheets.

In the context of the present invention, it has been found that the problems in unstacking the printed sheets frequently occur when the speed at which the sheets are printed has been particularly high, the problem being caused by this increased sheet printing speed. The sheets are stacked in a very short time after the application of the inks, so that the printing inks, optionally with overcoat, are not yet completely dried or cured on the film. The still wet printing inks and/or incompletely cured overcoats lead to a stronger adhesion of the labels to each other. In extreme cases, there is such an adhesion that printing ink is sometimes transferred with overcoat from the printed outside to the inner container side.

EP 0 545 650 B1 describes a polymer film which has five co-extruded, co-biaxially stretched layers and a vacuole-containing core layer of polypropylene homopolymer having intermediate layers of substantially vacuole-free polypropylene homopolymer arranged on both sides and in each case having an outer layer of heat-sealable polymer on the intermediate layers of substantially vacuole-free polypropylene homopolymer. The film is heat-sealable, wherein the intermediate layers of polypropylene homopolymer each have a thickness of 1 to 5 μm. In this case, the polymer film should be characterized by a good puncture resistance. In one embodiment, a polymer film having a density of 0.66 g/cm³, an optical density of 0.61 and a gloss of 50 at 20° is described.

EP 0 611 102 B1 discloses a biaxially oriented polypropylene film comprising a vacuole-containing base layer of polypropylene homopolymer having an intermediate layer of vacuole-free polypropylene homopolymer on the one surface and a printable outer layer on the vacuole-free polypropylene homopolymer intermediate layer. In this case, the printable outer layer is formed from a polyolefin mixed polymer which is composed of ethylene, propylene, but-1-ene and higher α-olefin units. In addition, on the surface opposite the vacuole-free intermediate layer, there is at least one further polymer layer whose outer surface is matte and comprises a mixture of incompatible polymers. Furthermore, the inner layer and/or the vacuole-free layer contains titanium dioxide. The film of this publication is used, among other things, for in-mold labeling.

EP 0 862 991 B1 relates to the use of a label as in-mold label produced from a biaxially oriented polymer film having a core layer of a vacuole-containing propylene homopolymer having a density of up to 0.70 g/cm³ on each surface of the core layer at least one substantially non-vacuole-containing layer. The ratio of the combined layer thicknesses of the intermediate layers and/or cover layers on the respective surfaces of the core layer is between 2:1 and 1:1.

WO 2009/010178 A1 describes the use of a multilayer, opaque, biaxially oriented polyolefin film of a vacuole-containing base layer and at least one inner cover layer as an in-mold label in deep drawing. In this case, the cover layer comprises at least 30-95% by weight of a copolymer and/or terpolymer I having a seal initiation temperature I of 70-105° C. and 5 to 70% by weight of an incompatible polyethylene, wherein the specifications in % weight are each based on the weight of the inner cover layer. The seal initiation temperature II of the inner cover layer should lie in the range of 80 to 110° C. in this context.

Furthermore, packaging films, in particular transparent packaging films, which are modified with polydialkylsiloxanes in the cover layer(s) to improve the sliding friction, are known in the prior art. This modification improves the coefficient of friction of the film so that these films can be better wound up and unwound during production and processing. This winding behavior is a critical characteristic, since processing takes place directly from the roll in the region of the packaging films, in which a corresponding bag is formed, filled and sealed during unwinding. There are no blanks or sheets in the region of packaging films. The printing is also optionally carried out in such a way that the film roll is hung and unwound in a printing machine, runs through the printing machine and is wound up again as a printed film. The printed film roll is then hung on the packing machine and processed into a packaging as described above.

The addition of polydialkylsiloxanes promotes smooth processing of the film rolls, although some properties of the films are adversely affected at the same time. Thus, the so-called poor-copy effect is known from films modified with polydialkylsiloxanes, which leads to a, usually undesirable, transfer of the polydialkylsiloxane on the opposite film surface. Polydialkylsiloxane impairs the printability and sealability of the films here. Furthermore, interactions between a polydialkylsiloxane-containing cover layer and corona treatments are known in the prior art. Thus, U.S. Pat. No. 5,945,225 describes where the corona treatment of a polydialkylsiloxane-containing cover layer impairs the sealability of the film to such an extent that it can no longer be used as a packaging film. This document teaches that the addition of hydrocarbon resins (hard resins) can compensate for the negative effect.

EP 2528737 makes positive use of this known effect and teaches the use of a polydialkylsiloxane-modified film in conjunction with cold seal adhesives. The corona treated polydialkylsiloxane-containing cover layer forms a release layer with respect to the cold seal adhesive without impairing the properties of the cold seal adhesive. Also, only transparent films for packaging are mentioned in this document.

It was an object of the present invention to provide a film which can be advantageously printed in the sheet-fed printing process at high speed and which can be reliably unstacked after stacking the printed sheets. The separation of the printed sheets should be reliable and trouble-free. There should be no transfer of printing ink and/or overcoat on the opposite unprinted outer surface. All these requirements should be met in particular for printing at high speed, so that no transfer takes place even when stacking printed sheets with moist or not fully cured inks and/or overcoats.

The other requirements with regard to the use as an in-mold label must not be impaired, that is, the film must have a good printability on its outside at the same time and basically run well in the sheet-fed printing process, that is, trouble-free underlapping but no shooting off of the sheets and the printed label must form a good adhesion to the container, and have good stackability and destackability as a single label.

This object is achieved by an opaque, multilayer, biaxially oriented polypropylene film made of a base layer and an outer cover layer and an inner matte cover layer, this inner cover layer containing at least two incompatible polymers and a surface roughness Rz of at least 2.0 μm at a cut-off of 25 mm and this inner matte cover layer containing a polydialkylsiloxane having a viscosity of 100,000 to 500,000 mm²/s and the surface of this inner matte cover layer being surface treated by means of corona.

The subclaims specify preferred embodiments of the invention.

Hereinafter, the surface or cover layer of the label film which, after labeling, is in contact with the container, is referred to as an inner surface or inner cover layer. The outer surface or outer cover layer is correspondingly the opposite surface or the opposite cover layer of the film which is printed and visible after labeling.

In the context of the present invention, it has been found that the polypropylene film according to the invention having a matte inner cover layer in the form of printed sheets can be stacked very well and that the unstacking is possible without any problem, even when the ink on the sheets is still moist or incompletely cured when stacking, when this matte, inner, unprinted cover layer contains a selected polydialkylsiloxane having a viscosity in the range of 100,000 to 500,000 mm²/s and when the surface of this inner cover layer has been subjected to a corona or flame treatment. Surprisingly, no ink transfer occurs under a wide range of application conditions, so that the unstacked printed sheets are free of ink transfers on the inner surface and the printed image remains undamaged on the outside.

The film has a very good underlapping of the sheets in the printing process without slipping or shooting off the lapping sheets. The unprinted inner surface of the sheet slides smoothly against the unprinted outer surface of the sheet, even with large format sheets. The newly cut sheet can be led under the previously cut off sheet, wherein the continuation of the lined-up underlapped sheets is not hindered. The properties of the film according to the invention contribute to a smooth printing of the large format sheets, whereby the printing speed can be further increased in this printing process. Surprisingly, even at these increased printing speeds, there are no problems with stacking and destacking of the printed sheets due to adhesions or ink transfer.

The other properties for the use of the film as in-mold label are also not impaired. The film can be printed well on the outer surface using a variety of inks and the printed label can also be well stacked and separated and the adhesion to the container is not impaired. As a result, a film is provided which can be processed at very high speeds to the label and at the end leads to a properly labeled visually appealing container.

In the context of the present invention, it has been found that the addition of a selected polydialkylsiloxane having a viscosity in the range of 100,000 to 500,000 mm²/s in the matte inner cover layer in conjunction with the corona or flame treatment of this matte inner cover layer is essential to the invention. It has been found that other conventional lubricants do not exhibit the desired effect or adversely affect other important film properties. The sliding behavior cannot be adjusted so that the film runs stable during the process through the addition of acid amides. But other measures, such as varying the surface roughness of the inner and outer surfaces, did not lead to satisfactory results. In particular, these measures cannot achieve the desired reliability in the printing process. Although the addition of erucic acid amides makes it possible to set a low coefficient of friction, the known problems always occur again and again at certain intervals. For example, the sheets adhere to each other in such a way that the printed sheets cannot be separated cleanly. This is attributed to the migration behavior of acid amides, which depends on the external conditions and leads to fluctuating film properties depending on the temperature and age of the film. Similarly, the optimization of the roughness is not as stable and reproducible as possible, since these values fluctuate in individual production batches in the usual context. Variations in the roughness could not solve the problem of ink transfer.

In the context of the present invention, it has been found that the coefficient of friction, which is conventionally measured in packaging films, is only a limited measure of the destackability of printed sheets. Despite the low coefficient of friction of the unprinted film, for example, by the use of erucic acid amides as a lubricant in the inner cover layer, the problems described occur much more often.

Surprisingly, using the selected polydialkylsiloxane in the matte inner cover layer, which is additionally treated with corona or flame, properties are achieved which lead to a trouble-free behavior of the sheets in the sheet-fed printing process, so that the printing speed can be increased without problems in destacking the printed sheets or ink transfers occurring. Compared with the other modifications that have been tested, these properties obtained are extremely stable and are not affected by external conditions. The film has stable properties, even when there are some fluctuations in the production process during the production of the film, or the external conditions differing up to the processing. The film according to the invention can be processed reliably to the label, even when the film quality itself is subject to certain fluctuations, for example, the roughness is slightly increased or decreased.

A film can thus be provided which can be printed particularly trouble-free in the sheet-fed printing process with high cycle rates. Even when the film quality itself or the quality of the printing inks is subject to certain fluctuations, the process of printing the sheets, guiding the lapped sheets, actually printing and stacking and unstacking the printed sheets need not be adjusted.

Surprisingly, there are no adverse effects on the other relevant properties. The label film can be printed well on the outside and surprisingly, the adhesion of the modified inside to the container is not impaired. There were serious concerns with regard to these adhesion properties since, for example, U.S. Pat. No. 5,945,225 describes such modified cover layers as “release layers” which should have a high release force compared to other surfaces.

The matte inner cover layer of the label film according to the invention must contain polydialkylsiloxane having a viscosity in the range of 100,000 to 500,000 mm²/s and additionally surface treated with corona or flame to ensure the desired improvements. Without the corona or flame treatment, or when the viscosity is lower, the polydialkylsiloxane transfers to the opposite outer surface and the printability of the outer surface is impaired.

It is also known that printability is significantly improved by plasma, corona or flame treatment. It was therefore expected that the corona or flame treatment of the matte inner cover layer would result in more frequent transfer of the printing ink from the outside to the inside, at least a greater adhesion of the outside to the inside surface in the sheet or label stack would occur. Surprisingly, the film according to the invention showed no increased adhesion of the matte treated surface to the printed outer surface, both in the printed sheets and in the stacked labels, rather, an improved, more stable separability of the sheets without ink transfer is surprisingly achieved.

It has surprisingly been found that the film according to the invention using the selected polydialkylsiloxane in the matte cover layer has very good separation properties not only despite, but even through corona treatment.

It has further been found that in the film according to the invention using polydialkylsiloxane in the inner cover layer, neither the printability of the outer surface of the label film nor the adhesion of the label to the container are impaired. It is known in the art that polysiloxanes are transferred to them upon contact with an opposing surface. This phenomenon is also described as a poor-copy effect. It was therefore to be expected that the polysiloxanes would be transferred to the opposite outer surface immediately after their production during the winding up of the film, thereby impairing the printability of this outer surface. However, this is not the case using the films according to the invention.

The film shows very good and stable properties after the surface treatment of the matte inner cover layer containing the selected polydialkylsiloxane having a viscosity of 100,000 to 500,000 mm²/s. The film can be printed very well on the opposite outer surface in the sheet-fed printing under a variety of conditions and despite certain variation in roughness, and these properties are ensured in time immediately after production and are stable over a long period of several months.

In a further embodiment of the invention, a siloxane-modified polyolefin can also be used instead of the selected polysiloxane having a viscosity of 100,000 to 500,000 mm²/s in conjunction with the corona or flame treatment. In this variant of the invention, a corona or flame treatment of the film surface is basically also possible but not necessary.

In a preferred embodiment, the label film is a five-layer film which has intermediate layers on both surfaces of the base layer. The printable outer cover layer is applied on the outer intermediate layer and the matte inner cover layer according to the invention is applied on the opposite inner intermediate layer. The surface treatment of the matte inner cover layer is carried out by means of corona or flame. The surface of the second outer cover layer can optionally be treated to improve the printability. The surface treatment of the outer cover layer can be done by means of corona, flame or plasma.

The base layer of the film contains at least 70% by weight, preferably 75 to 99% by weight, in particular 80 to 98% by weight, in each case based on the weight of the base layer, of propylene polymers and at most 30% by weight, preferably 1 to 25% by weight, in particular 2 to 20% by weight of vacuole-initiating fillers, and optionally further conventional additives in respectively effective amounts.

In general, the propylene polymer contains at least 90% by weight, preferably 94 to 100% by weight, in particular 98 to <100% by weight, of polypropylene units. The corresponding comonomer content of at most 10% by weight, or 0 to 6% by weight, or >0 to 2% by weight, when present, is generally derived from ethylene. The specifications in % by weight are each based on the propylene polymer.

Preferred are isotactic propylene homopolymers having a melting point of 140 to 170° C., preferably 150 to 165° C., and a melt flow index (measurement ISO 1133 at 2.16 kg load and 230° C.) of 1.0 to 10 g/10 min, preferably from 1.5 to 6.5 g/10 min. The n-heptane-soluble proportion of the polymer is generally 0.5 to 10% by weight, preferably 2 to 5% by weight, based on the starting polymer. The molecular weight distribution of the propylene polymer can vary. The ratio of the weight average Mw to the number average Mn is generally between 1 and 15, preferably from 2 to 10, most preferably from 2 to 6. Such a narrow molecular weight distribution of the propylene polymer of the base layer can be achieved, for example, by its peroxidic degradation or by production of the polypropylene by means of suitable metallocene catalysts. For the purposes of the present invention, highly isotactic or highly crystalline polypropylenes whose isotacticity according to ¹³C-NMR (triad) is at least 95%, preferably 96-99% are also suitable. Such highly isotactic polypropylenes are known per se in the prior art and are referred to as both HIPP and HCPP.

Furthermore, the base layer comprises vacuole-initiating fillers, in particular in an amount of at most 30% by weight, preferably 1 to 20% by weight, in particular 2 to 15% by weight, based on the weight of the base layer. In addition to the vacuole-initiating fillers, the base layer can contain pigments, for example, in an amount of 0.5 to 10% by weight, preferably 1 to 8% by weight, in particular 1 to 5% by weight. The specifications relate in each case to the weight of the base layer. When pigments are added, the proportion of polymers decreases accordingly. However, preferred embodiments contain no pigments, that is, <1% by weight, in particular no TiO₂, in the base layer.

For the purposes of the present invention, “pigments” are incompatible particles which substantially do not lead to the formation of vacuoles during stretching of the film. The coloring effect of the pigments is caused by the particles themselves. Pigments generally have an average particle diameter of from 0.01 to a maximum of 1 μm, preferably from 0.01 to 0.7 μm, in particular from 0.01 to 0.4 μm. Pigments comprise both so-called “white pigments,” which color the films white, and “colored pigments,” which give the film a colorful or black color. Typical pigments are materials such as aluminum oxide, aluminum sulfate, barium sulfate, calcium carbonate, magnesium carbonate, silicates such as aluminum silicate (kaolin clay) and magnesium silicate (talc), silicon dioxide and titanium dioxide, among which white pigments such as calcium carbonate, silicon dioxide, titanium dioxide and barium sulfate are preferably used.

The titanium dioxide particles are generally at least 95% by weight of rutile and are preferably used with a coating of inorganic oxides and/or of organic compounds having polar and nonpolar groups. Such coatings of TiO₂ are known in the prior art.

For the purposes of the present invention, “vacuole-initiating fillers” are solid particles that are incompatible with the polymer matrix and, upon stretching of the films, result in the formation of vacuole-like cavities, wherein the size, type and number of vacuoles depend on the size and amount of the solid particles and the stretching conditions, such as stretching ratio and stretching temperature. The vacuoles reduce the density and give the films a characteristic pearlescent, opaque appearance, which results from light scattering on the “vacuole/polymer matrix” interfaces. The light scattering on the solid particles themselves contributes comparatively little to the opacity of the film in general. In general, the vacuole-initiating fillers have a minimum size of 1 μm to result in an effective, that is, opacifying, amount of vacuoles. In general, the average particle diameter of the particles is 1 to 6 μm, preferably 1.5 to 5 μm. The chemical character of the particles plays a minor role if incompatibility is present.

Typical vacuole-initiating fillers are inorganic and/or organic materials incompatible with polypropylene such as aluminum oxide, aluminum sulfate, barium sulfate, calcium carbonate, magnesium carbonate, silicates such as aluminum silicate (kaolin clay) and magnesium silicate (talc) and silicon dioxide, among which calcium carbonate and silicon dioxide are preferably used. Suitable organic fillers are the polymers commonly used which are incompatible with the polymer of the base layer, in particular those such as HDPE, copolymers of cyclic olefins such as norbornene or tetracyclododecene with ethylene or propylene, polyesters, polystyrenes, polyamides, halogenated organic polymers, wherein polyesters such as polybutylene terephthalates are preferred. For the purposes of the present invention, “incompatible materials” or “incompatible polymers” refer to those materials or polymers which are present in the film as separate particles or as a separate phase.

The density of the film according to the invention can vary within a wide range, depending on the composition of the base layer. In this case, vacuoles contribute to a lowering of the density, whereas pigments, such as TiO₂, increase the density of the film due to the higher specific weight. Preferably, the density of the film is in the range of 0.4 to 0.8 g/cm³, in particular in the range of 0.5 to 0.75 g/cm³.

In addition, the base layer can contain conventional additives, such as neutralizing agents, stabilizers, anti-static agents and/or other lubricants, in respectively effective amounts. The following specifications in % by weight are based on the weight of the base layer.

Preferred anti-static agents are glycerol monostearates, alkali metal alkanesulfonates, polyether-modified, in particular ethoxylated and/or propoxylated, polydiorganosiloxanes (polydialkylsiloxanes, polyalkylphenylsiloxanes and the like) and/or the substantially straight-chain and saturated aliphatic, tertiary amines having an aliphatic radical having 10 to 20 carbon atoms and substituted by α-hydroxy-(C₁-C₄) alkyl groups, wherein N,N-bis-(2-hydroxyethyl) alkylamines having 10 to 20 carbon atoms, preferably 12 to 18 carbon atoms, in the alkyl radical are particularly suitable. The preferred amount of anti-static agent is in the range of 0.05 to 0.5% by weight.

Suitable lubricants are in particular higher aliphatic acid amides, higher aliphatic acid esters, waxes and metal soaps. The preferred amount of lubricant lies in the range of 0.01 to 3% by weight, preferably 0.02 to 1% by weight. Particularly suitable is the addition of higher aliphatic acid amides in the range of 0.01 to 0.25% by weight in the base layer. Especially suitable aliphatic acid amides are erucic acid amide and stearylamide. In the context of the present invention, it has been found that the addition of such lubricants, in particular also the addition of acid amides, does not positively influence the sliding behavior of the sheets, but can advantageously be used with regard to the winding behavior of the film.

Stabilizers which can be used are the customary stabilizing compounds for ethylene, propylene and other olefin polymers. Their additional amount preferably lies between 0.05 and 2% by weight. Particularly suitable are phenolic and phosphitic stabilizers, such as tris-2,6-dimethylphenyl phosphite. Phenolic stabilizers having a molecular mass of more than 500 g/mol are preferred, in particular pentaerythrityl-tetrakis-3-(3,5-di-tert-butyl-4-hydroxyphenyl) propionate or 1,3,5-trimethyl-2,4,6-tris (3,5-di-tert-butyl-4-hydroxybenzyl) benzene. In this case, phenolic stabilizers alone are advantageously used in an amount of 0.1 to 0.6% by weight, in particular 0.1 to 0.3% by weight, phenolic and phosphite stabilizers preferably in the ratio 1:4 to 2:1 and in a total amount of 0.1 to 0.4% by weight, in particular 0.1 to 0.25% by weight.

Preferred neutralizing agents comprise dihydrotalcite, calcium stearate and/or calcium carbonate having an average particle size of at most 0.7 μm, an absolute particle size of less than 10 μm and a specific surface area of at least 40 m²/g. In general, 0.02 to 0.1% by weight is added.

The film according to the invention comprises at least one inner cover layer and one outer cover layer. For the purposes of the present invention, the inner cover layer is the cover layer which, when labeled, faces the container and forms the connection between the container and the label. The inner cover layer is either in contact with the base layer or preferably in contact with the inner intermediate layer. For the purposes of the present invention, the outer cover layer is that cover layer which, when labeled, faces away from the container and, when labeled, shows facing outwards and is visible on the labeled container. The outer cover layer is generally in contact with the outer intermediate layer.

The inner cover layer generally has a thickness of 0.5 to 5 μm, preferably 0.8 to 3 μm. The outer cover layer generally has a thickness of 0.5 to 4 μm, preferably 0.5 to 2.5 μm. The inner intermediate layer generally has a thickness of 1.5 to 6 μm, preferably 2 to 4.5 μm. The outer intermediate layer generally has a thickness of 1 to 5 μm, preferably 1.5 to 3.5 μm. The total thickness of the film is preferably in a range of 30 to 100 μm, preferably in a range of 40 to 60 μm.

The matte inner cover layer of the label film contains at least two incompatible polymers (A) and (B) as essential constituents. Incompatible for the purposes of the present invention means that the two polymers form two separate phases and thereby produce an increased roughness of the surface. Such matte cover layers of incompatible polymers are known per se in the prior art.

In general, the cover layer is composed of (A) propylene homopolymer, copolymer and/or terpolymer of propylene, ethylene and/or butylene units and (B) polyethylene. In general, the inner cover layer contains at least 30 to 95% by weight, preferably 45 to 85% by weight, in particular 50 to 80% by weight of said propylene polymers (A) and 5 to 70% by weight, preferably 15 to 55% by weight, in particular 20 to 50% by weight of the polyethylene (B), in each case based on the weight of the inner cover layer.

Propylene copolymers or propylene terpolymers which are particularly suitable for the present purposes contain predominantly propylene units and additionally ethylene units and/or butylene units, that is, in particular propylene-ethylene copolymers, propylene-butylene copolymers or propylene-ethylene-butylene-terpolymers. The composition of the propylene copolymers or propylene terpolymers from the respective monomers can vary within the limits described below. In general, the propylene polymers contain over 50% by weight of polypropylene units, which is why they are also referred to as propylene mixed polymers. Preferred propylene mixed polymers contain at least 60% by weight, preferably 65 to 97% by weight of polypropylene units and at most 40% by weight, preferably 3 to 35% by weight of ethylene or polybutylene comonomer units. Furthermore, terpolymers which comprise 65 to 96% by weight, preferably 72 to 93% by weight of polypropylene units, and 3 to 34% by weight, preferably 5 to 26% by weight of polyethylene units and 1 to 10% by weight, preferably 2 to 8% by weight of polybutylene units are particularly advantageous.

The melt index of the propylene copolymers or propylene terpolymers is generally 0.1 to 20 g/10 min (230° C., 2.16 kg), preferably 0.1 to 15 g/10 min. The melting point can generally lie in a range of 70 to 140° C. In a preferred embodiment, propylene copolymers and/or propylene terpolymers whose melting point is at least 105 to 140° C., preferably 110 to 135° C. are used.

Suitable propylene homopolymers are those already described above for the base layer and can also be added to the inner cover layer, wherein the proportion of propylene homopolymer should generally not be >50% by weight, based on the weight of the inner cover layer.

The above-mentioned propylene polymers can optionally be mixed with each other. The proportions can be varied within any limits here. These mixtures are then used in the cover layer in the amounts described above for the propylene polymers.

Propylene copolymers and/or propylene terpolymers having a low seal initiation temperature (SIT) for the inner cover layer are preferred for films which are to be used as in-mold labels in deep drawing processes. Both these low-sealing propylene polymers and the composition of such low-sealing inner cover layers are described in detail in WO 2009/0101178, page 9, line 19 to page 13, line 12. This disclosure is hereby incorporated by reference.

For the deep drawn labels, preference is thus given to those propylene copolymers and/or propylene terpolymers which have a seal initiation temperature I of from 70-105° C., preferably from 75 to 100° C. In this case, the proportions of these low-boiling copolymers and/or terpolymers I and polyethylene in the inner cover layer should be selected so that the seal initiation temperature of the inner cover layer does not exceed 110° C., preferably in the range from 80°-110° C.

The second essential component of the inner cover layer is at least one polyethylene which is incompatible with the propylene polymers described above. Such incompatible mixtures of propylene polymers and polyethylenes are known per se in the prior art. The mixtures of the propylene polymers and the incompatible polyethylenes produce a surface roughness that generally gives the surface of the inner cover layer a matte appearance. “Incompatible” for the purposes of this invention thus means that a surface roughness is formed by the mixture of the propylene polymer with the polyethylene. The surface roughness Rz of the inner cover layer of incompatible polymers generally lies in a range of 2.0-6 μm, preferably 2.5-4.5 μm, at a cut-off of 0.25 mm.

Suitable incompatible polyethylenes are, for example, HDPE or MDPE. The HDPE generally has the properties described below, for example, an MFI (21.6 kg/190° C.) greater than 1 to 50 g/10 min, preferably 1.5 to 30 g/10 min, measured according to ISO 1133 and a viscosity number, measured according to DIN 53 728, Part 4, or ISO 1191, in the range of 100 to 450 cm³/g, preferably 120 to 280 cm³/g. The crystallinity is generally 35 to 80%, preferably 50 to 80%. The density, measured at 23° C. according to DIN 53 479, method A, or ISO 1183, preferably lies in the range from >0.94 to 0.96 g/cm³. The melting point, measured with DSC (maximum of the melting curve, heating rate 20° C./min), preferably lies between 120 and 140° C. Suitable MDPE generally has an MFI (21.6 kg/190° C.) of greater than 0.1 to 50 g/10 min, preferably 0.6 to 20 g/10 min, measured according to ISO 1133. The density, measured at 23° C. according to DIN 53 479, method A, or ISO 1183, preferably lies in the range from >0.925 to 0.94 g/cm³. The melting point, measured with DSC (maximum of the melting curve, heating rate 20° C./min), preferably lies between 115 and 135° C., preferably 115 to 130° C.

Optionally, the inner cover layer can contain other olefinic polymers in small amounts, as far as this does not impair the essential film properties.

According to the invention, the inner cover layer contains at least one polydialkylsiloxane having a viscosity of 100,000 to 500,000 mm²/s. The amount of polydialkylsiloxane in the inner cover layer generally lies in the range of 0.5 to 5% by weight, preferably 0.8-3% by weight, based on the weight of the inner cover layer. The other layers, in particular the second outer cover layer, contain/do not contain polydialkylsiloxane.

Polydialkylsiloxanes are polymers in which unbranched chains are built up alternately from successive silicon and oxygen atoms and each having two alkyl groups on the silicon atoms. The terminal silicon atoms of the chains have three alkyl groups. Alkyl groups are, for example, alkyl groups having 1 to 5 C atoms, wherein methyl groups, that is, polydimethylsiloxanes, are preferred. Polydialkylsiloxanes accordingly have no further functional groups. According to the invention, polydialkylsiloxanes are used whose viscosity is 100,000 to 500,000 mm²/s, preferably 150,000 to 400,000 mm²/s, in particular 250,000 to 350,000 mm²/s. The viscosity is related to the chain length and the molecular weight of the siloxanes. For example, siloxanes having a viscosity of at least 100,000 mm²/s generally have a molecular weight of at least 100,000 and a chain length of greater than 14,000 siloxane units.

The surface of the inner cover layer is subjected according to the invention to a corona or flame treatment. This treatment surprisingly changes the properties of the siloxane-containing cover layer such that both the desired separation properties and a good adhesion to the container and a good printability on the outside of the label film is given. Details about the corona or flame treatment are given below in the description of the production process.

In an alternative embodiment of the invention, the inner cover layer contains a siloxane-modified polyolefin instead of the polydialkylsiloxane. In this variant of the invention, a corona or flame treatment of the inner cover layer is basically also possible but not necessary. These modified polyolefins comprise one or more organopolysiloxane units, which are generally linked via ester bonds to the polymer chains of the polyolefins. These polymers are known per se and are also described as functionalized polyolefins. Siloxane-modified polyolefins are produced, for example, by the reaction of acid anhydride-grafted polyolefins with hydroxy-functional polysiloxanes in the melt or from a solvent. Condensation between the hydroxyl and anhydride groups results in permanent chemical bonding of the siloxane chains to the polymer matrix. Polyethylenes, polypropylenes or propylene copolymers are basically preferred as the base polymer for these modified polyolefins. Propylene copolymers are composed of propylene, ethylene and/or butylene units and contain predominantly (>70% by weight) of propylene units. Such siloxane-modified polyolefins are commercially available, for example, under the trade name Bynel or as masterbatches under the name HMB-6301 from Dow Corning. The production of siloxane-modified polyolefins is described, for example, in DE10059454 A1. The amount of siloxane-modified polyolefins is controlled such that in this embodiment, the polysiloxane content of the inner cover layer lies in a range of 0.5 to 5% by weight, preferably 0.8 to 3% by weight, based on the weight of the inner cover layer.

Optionally, in addition to said incompatible polymer and the polydialkylsiloxane essential to the invention or the siloxane-modified polyolefin essential to the invention, the inner cover layer can contain customary additives in respective effective amounts, and further polymers in small amounts (0 to <5% by weight), provided these additives do not impair the properties of the film essential to the invention.

These are, for example, some of the additives described above, such as neutralizing agents, stabilizers, anti-static agents and/or anti-blocking agents. The respective specifications in % by weight relate to the weight of the inner cover layer.

Particularly suitable anti-blocking agents are inorganic additives such as silicon dioxide, calcium carbonate, magnesium silicate, aluminum silicate, calcium phosphate and the like and/or incompatible organic polymers such as polyamides, polyesters, polycarbonates and the like, or crosslinked polymers such as crosslinked polymethyl methacrylate or crosslinked silicone oils. Silicon dioxide and calcium carbonate are preferred. The mean particle size is preferably between 1 and 6 μm, in particular 2 and 5 μm. The preferred amount of anti-blocking agent lies in the range of 0.05 to 5% by weight, preferably 0.1 to 3% by weight, in particular 0.2 to 2% by weight.

The polyolefin film according to the invention has a second outer cover layer on the side opposite the inner cover layer. The outer cover layer should have good adhesion to conventional printing inks. This outer cover layer can be applied to the surface of the base layer. Preferably, however, the film has an outer intermediate layer, so that the outer cover layer is applied to the surface of the outer intermediate layer. To further improve the printability, a corona, plasma or flame treatment is performed on the surface of the outer cover layer.

The outer cover layer is generally composed of polymers of olefins having 2 to 10 carbon atoms. The outer cover layer generally contains 95 to 100% by weight of polyolefin, preferably 98 to <100% by weight of polyolefin, in each case based on the weight of the cover layer(s).

Preferred olefinic polymers of the outer cover layer(s) are propylene homopolymers, propylene copolymers or propylene terpolymers II of ethylene, propylene and/or butylene units or mixtures of said polymers. These copolymers or terpolymers II contain no carboxylic acid monomers (or esters thereof). They are polyolefins. Preferred polymers among them are ethylene-propylene random copolymers having an ethylene content of 1 to 10% by weight, preferably 2.5 to 8% by weight, or propylene-butylene-1 random copolymers having a butylene content of from 2 to 25% by weight, preferably from 4 to 20% by weight, or ethylene-propylene-butylene-1 random terpolymers having an ethylene content of from 1 to 10% by weight and a butylene-1 content of 2 to 20% by weight, or a mixture or a blend of ethylene-propylene-butylene-1 terpolymers and propylene-butylene-1 copolymers having an ethylene content of 0.1 to 7% by weight and a propylene content of 50 to 90% by weight and a butylene-1 content of 10 to 40% by weight. The specifications in % by weight are based on the weight of the polymer.

The above-described propylene copolymers and/or propylene terpolymers II used in the outer cover layer generally have a melt flow index of from 1.5 to 30 g/10 min, preferably from 3 to 15 g/10 min. The melting point lies in the range of 120 to 145° C. The above-described blend of copolymers and terpolymers II has a melt flow index of 5 to 9 g/10 min and a melting point of 120 to 150° C. All above-mentioned melt flow indices are measured at 230° C. and a force of 21.6 N (DIN 53 735).

These embodiments described above show a gloss of 15 to 40 (at an angle of 20° C.) on the outer surface.

In a further embodiment, the outer cover layer can analogously contain, as described for the inner cover layer, an incompatible polymer and thus have a matte and rough surface.

This matte outer cover layer is composed of the above-described propylene homopolymers or copolymers and/or terpolymers of propylene, ethylene and/or butylene units (A) and polyethylene (B). In general, the outer cover layer contains at least 30 to 95% by weight, preferably 45 to 85% by weight, in particular 50 to 80% by weight of said propylene polymers (A) and 5 to 70% by weight, preferably 15 to 55% by weight, in particular 20 to 50% by weight of the polyethylene (B), in each case based on the weight of the outer cover layer.

For the outer cover layer, it is analogous that the mixture of the propylene polymers and the incompatible polyethylenes produces a surface roughness which gives the surface of the outer cover layer a matte appearance. The surface roughness Rz of the outer cover layer of incompatible polymers generally lies in a range of 2.0-6 μm, preferably 2.5-4.5 μm, at a cut-off of 0.25 mm.

Suitable incompatible polyethylenes are described in detail in connection with the inner cover layer. These polyethylenes are equally suitable for the matte outer cover layer.

Optionally, the above-described additives such as anti-static agents, neutralizing agents, anti-blocking agents and/or stabilizers can be added to the outer cover layer. The specifications in % by weight then relate accordingly to the weight of the cover layer. The outer cover layer contains no polydialkylsiloxane. No polydialkylsiloxane is incorporated and there is no polydialkylsiloxane on the surface of the outer cover layer that was transferred from the inner surface.

Suitable anti-blocking agents are already described in connection with the inner cover layer. These anti-blocking agents are also suitable for the outer cover layer. The preferred amount of anti-blocking agent for the outer cover layer lies in the range of 0.1 to 2% by weight, preferably 0.1 to 0.8% by weight.

In a particularly preferred embodiment, the surface of the outer cover layer is corona, plasma or flame treated. This treatment improves the adhesion properties of the film surface for subsequent decoration and printing, that is, to ensure the wettability with and adhesion of printing inks.

In general, the film of the invention comprises an inner intermediate layer arranged between the base layer and the inner cover layer, and an outer intermediate layer arranged between the base layer and the outer cover layer. The inner intermediate layer is in contact with the inner cover layer, the outer intermediate layer is in contact with the outer cover layer. Preferred embodiments of the film are thus five-layered.

The inner intermediate layer and the outer intermediate layer independently of each other contain at least one polymer of at least one olefin, preferably at least one propylene polymer, in particular at least one propylene homopolymer. Furthermore, the inner intermediate layer and the outer intermediate layer independently of each other can contain the usual additives described for the individual layers, such as anti-statics, neutralizing agents, lubricants and/or stabilizers, and optionally pigments.

Preferred polymers of the intermediate layers are isotactic propylene homopolymers having a melting point of 140 to 170° C., preferably 150 to 165° C., and a melt flow index (measurement ISO 1133 at 2.16 kg load and 230° C.) of 1.0 to 10 g/10 min, preferably from 1.5 to 6.5 g/10 min. The n-heptane-soluble proportion of the polymer is generally 0.5 to 10% by weight, preferably 2 to 5% by weight, based on the starting polymer. For the purposes of the present invention, the highly isotactic or highly crystalline polypropylenes described above for the base layer can be used in the intermediate layers and are advantageous, for example, for films having a thickness of less than 60 μm, preferably from 35 to 55, in particular 40 to 50 μm. Optionally, the use of highly crystalline polypropylenes in the intermediate layers can improve the stiffness of films having a particularly low density of the base layer.

Alternatively, the intermediate layers propylene homopolymers having a regular isotacticity (¹³C-NMR) of 90 to 96%, preferably 92 to <95% can be used, in particular for film having a thickness of >50 to 150 μm, preferably >55 to 100 μm.

The intermediate layer contains in each case 90-100% by weight of the described propylene polymers, preferably propylene homopolymers, and, optionally, additionally the additives mentioned. In addition, the inner intermediate layer and the outer intermediate layer, in particular the outer intermediate layer, contain pigments, in particular TiO₂, for example, in an amount of 2 to 8% by weight, wherein the polymer proportion is reduced accordingly.

The thickness of the intermediate layers is independent of one another and is generally greater than 1 μm and preferably lies in the range from 1.5 to 15 μm, in particular from 2 to 10 μm, for example, from 2.5 to 8 μm or from 3 to 6 μm.

Particularly advantageous embodiments have an outer intermediate layer which contains 4.5 to 30% by weight, in particular 5 to 25% by weight TiO₂ and a layer thickness of 0.5 to 5 μm, preferably 0.5 to <3 μm. Particularly advantageous embodiments have a thin outer cover layer of <2 μm, preferably >0 to <1.8 μm, for example 0.5 to <1.5 μm, having a high pigment content on this thin outer intermediate layer.

The total thickness of the film according to the invention is less than 150 μm, preferably less than 100 μm, in particular not more than 70 μm. On the other hand, it is preferably greater than 15 μm, preferably greater than 20 μm, in particular at least 25 μm. In this case, the base layer is generally the thickest layer of the film and preferably accounts for 40 to 99% of the total film thickness. The film can optionally have further layers.

The film is referred to as polypropylene film due to the preferred composition of the layers of propylene polymers. This means, for the purposes of the present invention, that the film has a proportion of at least 70% of propylene units, preferably 90 to 98% of propylene units, based on the film.

The film according to the invention can be produced in a manner known per se, for example by a co-extrusion process. In the context of this process, the melts corresponding to the individual layers of the film are simultaneously and jointly co-extruded through a flat die, the resulting film is removed for solidification on one or more rolls, the multilayered film is subsequently stretched (oriented), the stretched film is heat-set and subjected to a corona treatment on the inner surface, and optionally plasma, corona or flame treated on the outer surfaces.

A biaxial stretching (orientation) can be performed sequentially or simultaneously. The sequential stretching is generally performed sequentially, wherein the successive biaxial stretching, first stretched longitudinally (in the machine direction) and then laterally (perpendicular to the machine direction), is preferred. The further description of the film production takes place on the example of the preferred flat film extrusion with subsequent sequential stretching.

First, as is customary in the extrusion process, the polymer or the polymer mixture of the individual layers is compressed and liquefied in an extruder, wherein the optionally added additives can already be present in the polymer or in the polymer mixture. The melts are then extruded together and simultaneously through a flat die (slot die) and the multilayer melt is drawn off on one or more draw rolls, preferably at a temperature of 10 to 100° C., in particular 10 to 50° C., cooling and solidifying.

The undrawn prefilm-film thus obtained is then stretched generally longitudinally and transversely to the extrusion direction, resulting in orientation of the molecular chains. The longitudinal stretching is preferably performed at a temperature of 70 to 130° C., in particular 80 to 110° C., expediently with the aid of two rollers running quickly differently according to the desired stretch ratio and transverse stretching preferably at a temperature of 120 to 180° C. with the aid of a corresponding clip frame. The longitudinal stretching ratios advantageously lie in the range of 3 to 8, preferably 4 to 6. The transverse stretching ratios advantageously lie in the range of 5 to 10, preferably 7 to 9.

The stretching of the film is preferably followed by its heat-setting (heat treatment), wherein the film is advantageously kept at a temperature of 100 to 160° C. for about 0.1 to 10 s. Subsequently, the film is wound up in the usual manner with a winding device.

After biaxial stretching, the inner surface of the film is corona treated, preferably the outer surface is also plasma, corona or flame treated according to one of the known methods. The treatment intensity for both surfaces independently generally lies in the range of 35 to 50 mN/m, preferably 37 to 45 mN/m.

In corona treatment, it is expedient to proceed in such a way that the film is passed between two conductor elements serving as electrodes, wherein a high voltage, usually AC voltage (about 5 to 20 kV and 5 to 30 kHz) is applied between the electrodes, so that spraying or corona discharges can take place. The spray or corona discharge ionizes the air above the film surface and reacts with the molecules of the film surface to form polar inclusions in the substantially non-polar polymer matrix.

Processes for flame treatment are likewise known per se and are described, for example, in EP 0732 188. The treatment intensity is generally in the range of 37 to 50 mN/m, preferably 39 to 45 mN/m. In general, this flame treatment is performed by means of a flame without polarization. Polarized flames can also optionally be used. During the flame treatment, the film is guided over a chill roll, wherein a burner is mounted above this roll. This burner is generally mounted at a distance of 3 to 10 mm from the film surface/chill roll. The film surface undergoes an oxidation reaction during contact with the flame. Preferably, the film is cooled over the chill roll during the treatment. The roll temperature lies in the range of 15 to 65° C., preferably 20 to 50° C.

The films according to the invention are printed in the sheet-fed printing process. In general, a sheet-fed offset press suitable for this purpose comprises feeder, printing unit and delivery. The feeder serves to separate and feed the sheets into the first printing unit, which can be followed by further printing units. The ink or print image and possibly the overcoat are transferred to the surface in the printing units. After the sheets have run through all the printing units, they get into the delivery. This serves to stack the printed sheets. The film according to the invention is particularly suitable for fast printing machines which achieve a speed of 8000 to 18,000 sheets per hour, preferably 10,000 to 15,000 sheets per hour. The size of the sheets can be up to 1200×800 mm. The printed sheets are then separated again, the individual labels are cut to size or punched from the printed sheets and in turn stacked into a stack of individual printed labels. Optionally, the labels can be punched from the stacked sheets as described above on page 2. Stacks of printed labels are produced directly in this way. The labels can surprisingly be used in all conventional in-mold labeling. The film according to the invention is suitable as an in-mold label both by injection molding and by deep drawing. In this use, the film is applied during the molding process of the container and becomes an integral part of the molded container. The containers are generally produced from suitable propylene or ethylene polymers, that is, injection molded or deep drawn.

In the injection molding process, first of all, the individual, possibly cut-to-size labels are removed from a stack, so that they can be inserted into an injection mold. The mold is designed so that the melt flow of the polymer is injected behind the label and the front side of the film rests against the wall of the injection mold. When injecting, the hot melt combines with the label. After injecting, the mold opens, the molded part with label is ejected and cools down. As a result, a labeled container is produced on which the label adheres wrinkle-free and optically perfect on the container.

When injecting, the injection pressure preferably lies in a range of 300 to 600 bar. The plastics used, in particular propylene polymers or polyethylenes, expediently have a melt flow index of around 40 g/10 min. The injection temperatures depend on the plastic used. In some cases, the mold is additionally cooled and a sticking of the molded part to the mold is to be avoided.

Alternatively, the use of the film according to the invention in container forming by means of a deep drawing process is particularly advantageous. When deep drawing, unoriented thick plastic plates, usually cast PP or PS (polystyrene), are heated in a thickness of preferably about 200-750 μm and preferably pulled or pressed by means of vacuum or punch tools in a corresponding molding tool. Again, the single label is inserted into the mold and bonds to the actual container during the molding process. As a rule, considerably lower temperatures are used than during the injection molding of the container. They are therefore preferred as labels having a low-sealing inner cover layer.

In the following, the present invention is further illustrated by examples and comparative examples, without thereby limiting the inventive concept.

In thus case, the following measurement methods were used to characterize the raw materials and the films:

Melt Flow Index

The melt flow index of the propylene polymers was measured according to ISO 1133 at 2.16 kg load and 230° C. and at 190° C. and 21.6 kg for polyethylenes.

Melting Points

The melting point is determined according to DIN 51007 as the maximum of the melting curve from a DSC measurement, wherein the melting curve is recorded at a heating rate of 20 K/min.

Density

The density of the polymers is determined according to DIN 53 479, method A. The density of the films is calculated from the measured thickness and the measured surface weight (ISO 4593).

Surface Tension

The surface tension was determined by means of an ink method according to DIN ISO 8296.

Roughness Measurement

The roughness values Rz of the films were measured on the basis of DIN 4768 part 1 and DIN 4777 and DIN 4772 and 4774 by means of a digital microscope from the company Leica, wherein the cut-off of the RC filter according to DIN 4768/1 had been adjusted to 0.25 mm.

Gloss Measurement

The measurement was carried out according to DIN EN ISO 2813 at an angle of 60°. A polished, dark-colored glass plate having a refractive index of 1.567 (measured at a wavelength of 587.6 nm and 25° C.) was used as a standard, whose gloss corresponds to 100 gloss units.

Ink Transfer

First, film strips are cut to a size of about 7 cm×30 cm. Half of these strips are printed with a black offset ink on the outer cover layer using an IGT offset printing device C1. The printed area is approximately 0.0071 m2, the ink application is 1 g/m2, and the contact pressure is 100 N. Immediately after printing, the printed surface is covered with a second strip of the same size (upper strip), wherein the inner cover layer (of the upper strip) is placed on the printed surface of the printed (lower) strip. In each case, 4 pairs of strips are prepared and fixed side by side on a DIN A4 sheet and covered with a particle board (28 cm×37 cm×2 cm, 1.2 kg). Subsequently, the particle board is weighted with an additional weight (0.5 kg, 5 kg, 20 kg). After 24 hours, the weights and the particle board are removed and the lower and upper strips are separated from each other by hand. The transfer of ink from the printed lower stripe to the inner cover layer of the unprinted upper stripe is visually assessed.

Release Force Determination

To evaluate the separability of printed sheets, the force which is required to separate superimposed film layers is determined. Rectangular patterns are cut to size from the films according to the examples and the comparative examples. Film layers of these patterns are stacked on each other so that the inner surface and the outer surface of the film are respectively in contact. In order to be able to clamp the film samples in the tensile test machine, a few centimeters wide strip is respectively covered at the edge of the sample, for example, with a paper. In addition, each second contact surface is completely covered in order to be able to separate two superimposed film patterns for the purpose of measurement.

The stack of individual film layers is pressed by means of a rocker press at a pressure of 100 N/cm² at room temperature 24 hours to simulate the conditions in practice. Thereafter, the film samples are separated from two samples each, cut into 30 mm wide strips and clamped in a tensile testing machine (for example, Zwick), so that the film layers are separated from each other at an angle of two times 90°. The force required to separate the film layers in this case is measured. The average of three measurements is used for the evaluation.

Viscosity

The viscosity is measured by means of a rotational viscometer according to DIN 53019 parts -1 to -4.

Determination of the Seal Initiation Temperature (SIT)

Two film strips are cut and placed on top of each other with the cover layers to be tested. Using the sealing device HSG/ETK from Brugger, heat-sealed samples (sealing seam 20 mm×100 mm) are produced by sealing the superimposed strips at different temperatures with the aid of two heated sealing jaws at a sealing pressure of 10 N/cm2 and a sealing time of 0.5 s. Test strips of 15 mm width are cut from the sealed samples. The T-seam strength, that is, the force required to separate the test strips, is determined using a tensile testing machine at a removal speed of 200 mm/min, wherein the sealing seam plane forms a right angle to the tensile direction. The seal initiation temperature is the temperature at which a seal strength of at least 1.0 N/15 mm is achieved.

The invention is now illustrated by the following examples.

### EXAMPLE 1 (ONE SIDE MATTE, 1.5% PDMS)

After the co-extrusion process, a five-layer prefilm was extruded from a slot die. This prefilm was drawn off on a chill roll, solidified and then oriented in the longitudinal and transverse directions and finally fixed. The surface of the outer and inner cover layers was pretreated by means of corona. The five-layered film had a layer construction of inner cover layer/inner intermediate layer/base layer/outer intermediate layer/outer cover layer. The individual layers of the film had the following composition:
inner cover layer I (2.3 μm):
˜60% by weight of ethylene-propylene copolymer having a melting point of 135° C. and a melt flow index of 7.3 g/10 min at 230° C. and 2.16 kg load (ISO 1133)
˜38.5% by weight MDPE having an MFI of 14.4 g/10 min (21.6 kg and 190° C.), density of 0.937 g/ccm3 and a melting point of 126° C.
1.5% by weight polydimethylsiloxane having a viscosity of 300,000 mm²/s.
0.33% by weight SiO₂ as an anti-blocking agent having a mean particle size of 5 μm
inner intermediate layer I (4.0 μm)
99.88% by weight of propylene homopolymer having an n-heptane-soluble proportion of 4.5% by weight (based on 100% PP), a melting point of 165° C. and a melt flow index of 3.2 g/10 min at 230° C. and 2.16 kg load (ISO 1133)
0.12% by weight of erucic acid amide (ESA)
base layer (40.2 μm)
85.95% by weight of propylene homopolymer (PP) having an n-heptane-soluble proportion of 4.5% by weight (based on 100% PP) and a melting point of 165° C. and a melt flow index of 3.2 g/10 min at 230° C. and 2.16 kg load (ISO 1133)
14% by weight calcium carbonate having a mean particle diameter of 3.5 μm
0.05% by weight of erucic acid amide (ESA)
outer intermediate layer II (3.0 μm)
94% by weight of propylene homopolymer (PP) having an n-heptane-soluble proportion of 4.5% by weight (based on 100% PP), a melting point of 165° C. and a melt flow index of 3.2 g/10 min at 230° C. and 2.16 kg load (ISO 1133)
6% by weight TiO₂ having an average particle diameter of 0.1 to 0.3 μm outer cover layer II (0.8 μm):
˜100% by weight of ethylene-propylene copolymer having a melting point of 135° C. and a melt flow index of 7.3 g/10 min at 230° C. and 2.16 kg load (ISO 1133)

All layers of the film additionally contained stabilizer and neutralizing agent in conventional amounts.

More specifically, the following conditions and temperatures were selected in the production of the film:
Extrusion: Extrusion temperature about 250° C.
Chill roll: Temperature 25° C.
Longitudinal stretching: T=120° C.
Longitudinal stretching by a factor of 4.8
Transverse stretching: T=155° C.
Transverse stretching by a factor of 8
Fixation T=133° C.

The film was surface treated on both surfaces by means of corona. The film had an opaque appearance and a density of 0.56 g/cm³ and a thickness of 50 μm.

### EXAMPLE 2 (ONE SIDE MATTE, 1% PDMS)

A film was produced according to Example 1, in contrast to Example 1, the content of polydimethylsiloxane was reduced to 1% by weight. The thicknesses of the layers, and the composition of all other layers, and the conditions during the production of the film remained unchanged.

### EXAMPLE 3 (ONE SIDE MATTE, 2% PDMS)

A film was produced according to Example 1, in contrast to Example 1, the content of polydimethylsiloxane was reduced to 2% by weight. The thicknesses of the layers, and the composition of all other layers, and the conditions during the production of the film remained unchanged.

### EXAMPLE 4 (TWO SIDE MATTE, 1.5% PDMS)

A film was produced according to Example 1, in contrast to Example 1, the composition of the outer cover layer was changed. The outer cover layer now had the same composition as the inner cover layer, in addition, the thickness of the inner cover layer was reduced to 1.5 μm. The thicknesses of the layers, and the composition of all other layers, and the conditions during the production of the film remained unchanged.

### EXAMPLE 5 (TWO SIDE MATTE, 1.5% PDMS WITHOUT INNER ZWS)

A film was produced according to Example 3, in contrast to Example 3, the inner intermediate layer was omitted, thus producing a four-layered film. The thickness of the base layer was increased by 4 μm to obtain a film of comparable thickness. The thicknesses of the other layers, and the composition of all other layers, and the conditions during the production of the film remained unchanged.

### EXAMPLE 6 (ONE SIDE MATTE, 1.5% PDMS+TAFMER)

A film was produced according to Example 1, in contrast to Example 1, the composition of the inner cover layer was changed. A polymer having a low melting point was additionally added to the inner cover layer. The thicknesses of the layers, and the composition of all other layers, and the conditions during the production of the film remained unchanged.
inner cover layer I (2.3 μm):
˜20% by weight of ethylene-propylene copolymer having a melting point of 135° C. and a melt flow index of 7.3 g/10 min at 230° C. and 2.16 kg load (ISO 1133)
˜40% by weight C3C4 copolymer Tafmer XM7070
˜38.5% by weightMDPE having an MFI of 14.4 g/10 min (21.6 kg and 190° C.), density of 0.937 g/ccm3 and a melting point of 126° C.
1.5% by weight polydimethylsiloxane having a viscosity of 300,000 mm²/s.
0.33% by weight SiO₂ as an anti-blocking agent having a mean particle size of 5 μm

### COMPARATIVE EXAMPLE 1 (ONE SIDE MATTE, WITHOUT PDMS)

A film was produced according to Example 1, in contrast to Example 1, the composition of the inner cover layer was changed. The inner cover layer now contained no polydialkylsiloxane. The thicknesses of the layers, and the composition of all other layers, and the conditions during the production of the film remained unchanged.

### COMPARATIVE EXAMPLE 2 (ONE SIDE MATTE, 1.5% PDMS WITH LOW VISCOSITY)

A film was produced according to Example 1, in contrast to Example 1, the composition of the inner cover layer I was changed. In contrast to Example 1, instead of the polydimethylsiloxane having a viscosity of 300,000 mm²/s, a polydimethylsiloxane having a viscosity of 30,000 mm²/s was used in the same amount. The thicknesses of the layers, and the composition of all other layers, and the conditions during the production of the film remained unchanged.

### COMPARATIVE EXAMPLE 3 (ONE SIDE MATTE, 1.5% PDMS WITHOUT CORONA)

A film was produced according to Example 1, in contrast to Example 1, no surface treatment of the inner cover layer was performed. The thicknesses of the layers, and the composition of all other layers, and the conditions during the production of the film remained unchanged.

### COMPARATIVE EXAMPLE 4 (TWO SIDE GLOSS, 1.5% PDMS WITHOUT MDPE)

A film was produced as described in Example 1. In contrast to Example 1, no MDPE was added to the inner cover layer. The content of propylene polymer was correspondingly increased to ˜98% by weight. The other composition and process conditions in the production of the film were not changed.
˜98% by weight of ethylene-propylene copolymer having a melting point of 135° C. and a melt flow index of 7.3 g/10 min at 230° C. and 2.16 kg load (ISO 1133)
1.5% by weight polydimethylsiloxane having a viscosity of 300,000 mm²/s.
0.33% by weight SiO₂ as an anti-blocking agent having a mean particle size of 5 μm

### COMPARATIVE EXAMPLE 5 (ONE SIDE MATTE, ESA INSTEAD OF PDMS)

A film was produced according to Example 1, in contrast to Example 1, the composition of the inner cover layer I was changed. In contrast to Example 1, no polydimethylsiloxane was used, but instead, an erucic acid amide was used in an amount of 0.5% by weight. The thicknesses of the layers, and the composition of all other layers, and the conditions during the production of the film remained unchanged.

The films according to the examples and the comparative examples were initially stored under different conditions for different periods and then examined with regard to their properties. Subsequently, the films were printed by sheet-fed printing process. The printed sheets were stacked. The printed sheets were then separated, the respective labels punched out of the sheet and the labels stacked in turn.

The stacked labels were then used in the injection molding process and in the deep drawing process as labels. The results are summarized in the table below.

The use according to the invention is described in detail below:

The films according to the examples and the comparative examples were cut into large-sized sheets of 70 cm×70 cm and stacked. The individual sheets were printed with a 4-fold repeat and the printed sheets were stacked. The repeats were punched out as individual labels from the printed sheets, stacked and finally provided on a labeling machine. The labels were used to label deep-drawn and injection-molded containers.

The films according to Examples 1 to 5 could be printed at high speed in the sheet-fed printing process and the printed sheets could be separated without ink transfer. The speed could be increased to up to 10,000 sheets per hour when printing the sheets. The labels which were punched from the sheets could also be easily stacked and unstacked and showed a good adhesion to the container. Optically flawless labeled containers were produced in this way.

The films according to the comparative examples could not be processed at this speed, both the printing and the labeling process speed had to be reduced (see table). Despite reduced speed, false or double feed disturbances occurred to varying degrees, which sometimes required the printing process or the labeling process to be interrupted.

TABLE

| | | Sheet-fed | | | Adhesion to | | |
|---|---|---|---|---|---|---|---|
| | | printing process | | Sheet stack | the container | | Printability |
| | | V | Run | Ink transfer/ | Injec- | Deep | of the |
| Example | Film structure | Max | process | destackability | tion | draw | outside |
| 1 | one side matte, 1.5% PDMS | ++ | ++ | None/+++ | +++ | + | +++ |
| 2 | one side matte, 1.0% PDMS | ++ | ++ | barely visible/++ | +++ | + | +++ |
| 3 | one side matte, 2.0% PDMS | +++ | +++ | None/+++ | +++ | + | ++ |
| 4 | two side matte, 1.5% PDMS | +++ | +++ | None/++++ | +++ | + | ++* |
| 5 | two side matte, 1.5% PDMS | ++ | ++ | None/++ | +++ | + | ++* |
| | without inner ZWS | | | | | | |
| 6 | one side matte, 1.5% PDMS + | ++ | ++ | None/+++ | +++ | ++ | +++ |
| | Tafmer | | | | | | |
| VB 1 | one side matte, without PDMS | +/− | +/− | Very clear/− | +++ | + | +++ |
| VB 2 | one side matte, 1.5% PDMS | ++ | ++ | None/− | ++ | + | −− |
| | with low viscosity | | | | | | |
| VB 3 | one side matte, 1.5% PDMS | +++ | +++ | Clear/++ | ++ | + | −−− |
| | without corona | | | | | | |
| VB 4 | two side gloss, 1.5% PDMS | + | + | None/−− | +++ | Blow | +++ |
| | without MDPE | | | | | | |
| VB 5 | one side matte, ESA instead | +/− | +/− | Clear/−** | ++ | − | ++ |
| | of PDMS | | | | | | |

*lower gloss
**erratic

1. An opaque multilayer biaxially oriented polypropylene film comprising at least one vacuole-containing base layer and a printable outer cover layer and an inner matte cover layer, the inner cover layer containing at least two incompatible polymers and having a surface roughness Rz of at least 2.0 μm at a cut-off of 25 μm, characterized in that the inner matte cover layer contains a polydialkylsiloxane which has a viscosity of 100,000 to 500,000 mm²/s and the surface of this inner cover layer is surface treated by means of corona treated or the inner cover layer contains a siloxane-modified polyolefin.

2. The film according to claim 1, characterized in that the mixture of incompatible polymers contains at least one polyethylene and one propylene polymer.

3. The film according to claim 1 or 2, characterized in that the polyethylene is an HDPE or an MDPE and the polypropylene polymer is a propylene copolymer or propylene terpolymer or a propylene homopolymer.

4. The film according to any one of claims 1 to 3, characterized in that the inner cover layer contains >0.5% by weight of polydialkylsiloxane, based on the weight of the inner cover layer.

5. The film according to any one of claims 1 to 4, characterized in that the polydialkylsiloxane has a viscosity of 150,000 to 400,000 mm²/s.

6. The film according to any one of claims 1 to 5, characterized in that the inner cover layer contains >0.5% by weight of a siloxane-modified polyolefin, based on the weight of the inner cover layer.

7. The film according to one or more of claims 1 to 6, characterized in that the thickness of the inner cover layer is 0.5 to 5 μm.

8. The film according to one or more of claims 1 to 7, characterized in that the inner cover layer additionally contains anti-blocking agents, preferably crosslinked silicones or crosslinked polymethyl methacrylate particles.

9. The film according to one or more of claims 1 to 8, characterized in that the outer cover layer is composed of propylene polymers and has a gloss of 15 to 40.

10. The film according to one or more of claims 1 to 8, characterized in that the outer cover layer contains propylene polymers and an incompatible polyethylene and surface roughness Rz in a range of 2.0-6 μm at a cut-off of 0.25 mm and the Rz values of the inner and outer surface differ by a maximum of 2 μm.

11. The film according to one or more of claims 1 to 8, characterized in that the film additionally has an inner intermediate layer and an outer intermediate layer and the outer intermediate layer has a thickness of 0.5 to 5 μm and contains 4.5 to 30% by weight of pigments, preferably TiO₂.

12. A use of a film according to any one of claims 1 to 11 in sheet-fed offset printing, characterized in that the sheets are printed and stacked.

13. A use of a film according to any one of claims 1 to 11 as an in-mold label in the deep drawing process.

14. The use according to claim 13, characterized in that the inner cover layer has a seal initiation temperature of 80 to 110° C.
